(19) United States
(12) Patent Application Publication
(10) Pub. No.: US 2008/0302875 A1
(43) Pub. Date: Dec. 11, 2008

(54) Communication terminal with contactless IC card system

(75) Inventor: Yung-Chieh Chien, Taipei (TW)

Correspondence Address: BACON & THOMAS, PLLC, 625 SLATERS LANE, FOURTH FLOOR, ALEXANDRIA, VA, 22314-1176, US

(73) Assignee: Taisys Technologies Co., Ltd., Taipei (TW)

(21) Appl. No.: 11/808,441

(22) Filed: Jun. 11, 2007

(51) Int. Cl. G06K 19/077

(52) U.S. Cl. 235/492

(57) ABSTRACT

A communication terminal with a contactless IC card is disclosed. The portable communication apparatus for a contactless transmission, includes a main device having a casing and a socket disposed therein for holding a contactless IC card; a pad set disposed on the casing of the main device; a connecting circuit for electrically connecting the socket to the pad set; and an antenna disposed on the casing, having a contact terminal set covering the pad set for coupling to the contactless IC card via the connecting circuit and transmitting data wirelessly while the contactless IC card is inserted into the socket.

### FIELD OF THE INVENTION

The present invention relates to a contactless IC card system, and more particularly, to a contactless IC card system for use with a communication terminal, e.g., a mobile phone.

### BACKGROUND OF THE INVENTION

Magnetic prepaid cards, widely available in the market, are highly convenient for users in that they can be used anonymously for an indefinite term by unspecified number of persons. However, the magnetic prepaid cards are always accompanied by a risk of unauthorized rewriting of data such as amount information and have a security weakness. Thus, in recent years, for the purpose of increasing security, such a magnetic card is replaced by an IC card. Accordingly, various IC cards are introduced to meet extensive consumer demands in hope of bringing a quicker, more convenient and secured consuming environment for consumers. The IC cards have a size approximately equal to that of a business card, which is easy to carry and it also includes a microchip for storing several tens of bytes to several tens of kilobytes of data. The IC cards have the functions of storing data and even executing application programs, and thus the IC cards are extensively used in many areas including identification cards, credit cards, electronic wallet, membership cards, access card, digital authentication cards, health care cards and telephone cards, etc. In general, an IC card is much more secured than a traditional magnetic card.

In recent years, contactless IC card and mobile phone become indispensable in our daily life. Therefore, finding a way of integrating the contactless IC card and the mobile phone to achieve the all-in-one function and effectively control consumer information, enhance data transmission rate and locate lost phones demands immediate attentions. As described in U.S. Pat. No. 6,973,327, it discloses an IC chip with IC card functions, a contactless IC card antenna, and an antenna connection circuit for connecting the IC chip and the contactless IC card antenna are provided on a mount board, and are combined to form a communication module. As shown in FIG. 1A and FIG. 1B, they are a rear view and a side view, respectively, of the communication module 1 mounted on the mobile phone 2. Meanwhile, the communication module 1 includes a package case 11, an IC chip 12 (an external communication means which operates as a contactless IC card control section), a contactless IC card antenna 14, an antenna connection circuit 16, a mount board 18, a connector 19 (a connection means), a shield member 10 and a rubber member 13. The package case 11 is a protective casing for the mount board 18. However, in FIG. 1A, a first chassis 20 of the mobile phone 2 is shown with a rear surface 20b of the first chassis 20 removed. The communication module 1 can be used while mounted on the mobile phone 2. The use of the communication module 1 is not limited to mobile phones, and may be used with mobile terminals such as PDAs and the like. The mobile phone 2 has the first chassis 20, and a second chassis 60. The first chassis 20 comprises the ear receiver 22, the LCD panel 24, a junction circuit board 26 and a connector 28. The ear receiver 22 is used for hearing sounds by having it held around the ear of a mobile phone user, and contains metal. The LCD panel 24 displays text, images and the like to the mobile phone user, and also contains metal. The ear receiver 22 and the LCD panel 24 are positioned on a surface of the first chassis 20. The junction circuit board 26 relays electrical power from a power source and control signals from a control section, and splits them between the ear receiver 22, the LCD panel 24 and the communication module 1. The junction circuit board 26 is built into the first chassis 20. The connector 28 connects the junction circuit board 26 and the connector 19 of the communication module 1. The second chassis 60 is connected to the first chassis 20, and has a telecommunication antenna 62. The telecommunication antenna 62 is provided to perform communication as a mobile phone. The communication module 1 is inserted into the first chassis 20 from a top surface 20a of the first chassis 20 by being moved in the direction indicated by the arrow shown in FIG. 1. In so doing, the connector 19 of the communication module 1 and the connector 28 of the first chassis become connected. Also, the communication module 1 projects from the rear surface 20b of the first chassis 20. Thus, the distance between the contactless IC card antenna 14 of the communication module 1 and the ear receiver 22 and electronic circuits of the LCD panel 24 of the mobile phone 2, both of which contain metal, can be maximized, thereby reducing the effects of the metal on the magnetic field. The direction indicated by the arrow shown in FIG. 1, however, is only an example of an insertion direction, and the communication module 1 may be inserted from other directions, or from the rear surface 20b. Also, by moving the communication module 1 in the direction opposite to that shown by the arrow in FIG. 1, the communication module 1 can be removed from the mobile phone 2. However, the communication module 1 and the mobile phone 2 couldn't be integrated into a combined system for user. One of the problems encountered in daily use of such a variety of cards lies in that one of the cards might not be available when it is to be used, no matter whether it is left at home, its credit has been run out, or it has expired. In addition, administration and carry of various cards is inconvenient. Therefore, contactless IC module and a mobile phone system tend to be integrated into a unity.

In general, an integrated card system with contactless IC module should include an antenna for transmitting data. The antenna is usually folded and covers a battery of a mobile phone. However, the form of antenna should be in accordance with that of the contactless card, such as VISA® card. When VISA WAVE® transaction is used in a transportation system, there should be an antenna validated by VISA®. Each form of contactless card merely validates some specific forms of antennas. Those antennas won't be suitable to dispose into any mobile phone, and more particularly, to a mobile phone in small size. It is inconvenient and will cost a lot to provide mobile phones in suitable size for contactless system.

Although some contactless IC cards for a mobile phone are technically feasible, in practice they are very inconvenient to implement. Meanwhile, the prior art fails to introduce a contactless system to a communication terminal easily. Therefore, it needs to provide a contactless IC card system for use with a communication terminal, which introduces a pad set disposed outside of the communication terminal for facilitating to build a contactless IC card system into the communication terminal, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a contactless IC card system for use with a communication terminal, which introduces a pad set disposed on outside of the communication terminal for facilitating to setup a contactless IC card system into the communication terminal, and can rectify those drawbacks of the prior art and solve the above problems.

In accordance with an aspect of the present invention, an contactless IC card system for use with a portable communication apparatus having a casing, includes a contactless IC card disposed in the portable communication apparatus; a pad set disposed on the casing of the portable communication apparatus; a connecting circuit for connecting the contactless IC card to the pad set; and an antenna disposed on the casing of the portable communication apparatus, having a contact terminal set covering the pad set for coupling to the contactless IC card and transmitting data wirelessly.

Certainly, the portable communication apparatus can be one of a mobile phone and a personal digital assistant.

Preferably, the contactless IC card system further includes a hologram disposed on the antenna.

Preferably, the antenna is a flexible antenna.

Preferably, the flexible antenna is looped or wound on a flexible board.

In accordance with another aspect of the present invention, a portable communication apparatus for a contactless transmission, includes a main device having a casing and a socket disposed therein for holding a contactless IC card; a pad set disposed on the casing of the main device; a connecting circuit for electrically connecting the socket to the pad set; and an antenna disposed on the casing, having a contact terminal set covering the pad set for coupling to the contactless IC card via the connecting circuit and transmitting data wirelessly while the contactless IC card is inserted into the socket.

Certainly, the portable communication apparatus can be one of a mobile phone and a personal digital assistant.

Preferably, the contactless IC card system further includes a hologram disposed on the antenna.

Preferably, the antenna is looped or wound on a flexible board.

### BRIEF DESCRIPTION OF THE DRAWING

The above objects and advantages of the present invention will become more readily apparent to those ordinarily skilled in the art after reviewing the following detailed description and accompanying drawings, in which:

FIG. 1A illustrates a rear view of a communication module as mounted on a mobile phone according to the prior art;

FIG. 1B illustrates a side view of a communication module as mounted on a mobile phone according to the prior art;

FIG. 2 illustrates a functional diagram of a contactless IC card system for use with a portable communication apparatus according to the present invention; and

FIG. 3 illustrates a portable communication apparatus with a contactless IC card system for a contactless transmission according to the present invention.

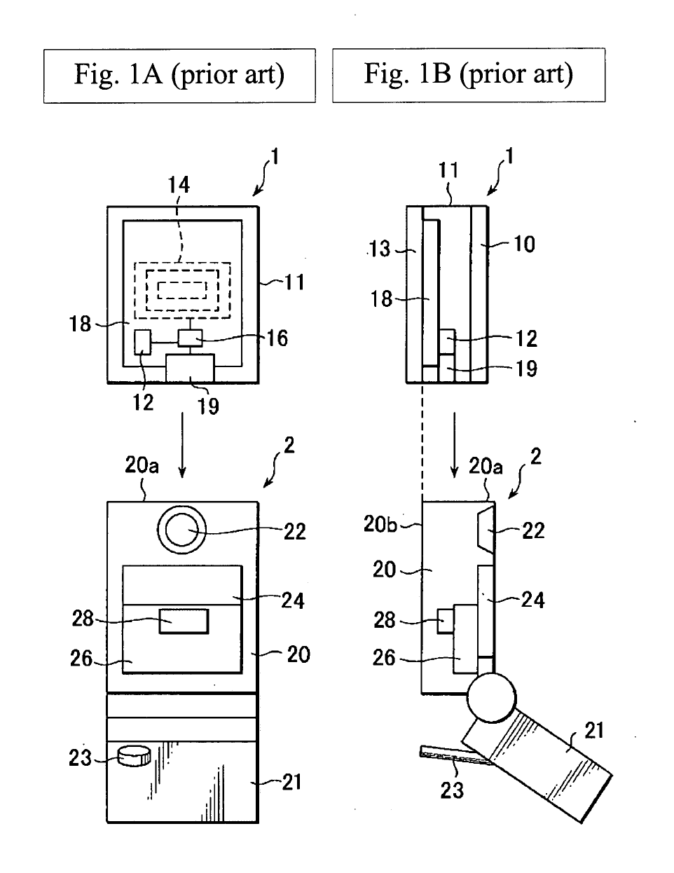

### DETAILED DESCRIPTION OF THE PREFERRED EMBODIMENT

The present invention will now be described more specifically with reference to the following embodiment. It is to be noted that the following description of preferred embodiment of this invention is presented herein for purpose of illustration and description only; it is not intended to be exhaustive or to be limited to the precise form disclosed.

Accordingly, the prior art is limited by the above problems. It is an object of the present invention to provide a contactless IC card system for use with a communication terminal, which is capable of facilitating to build a contactless IC card system into the communication terminal.

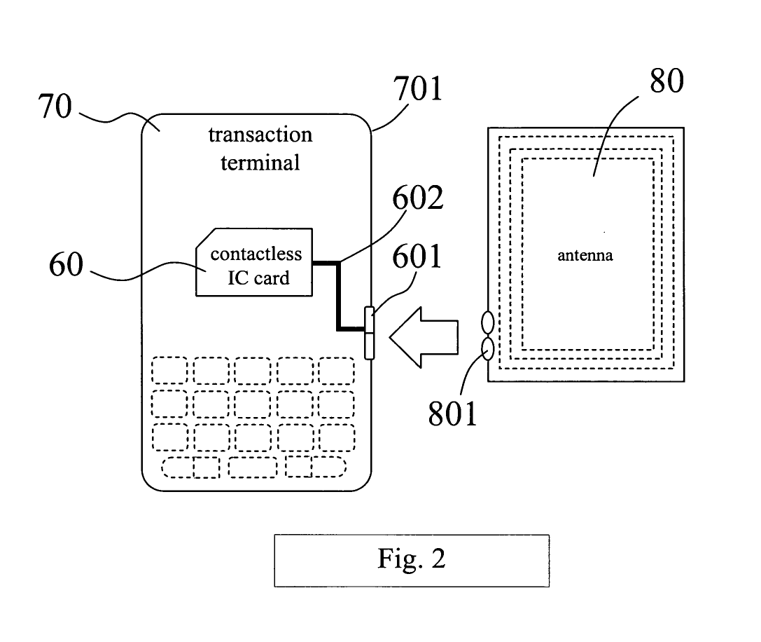

Please refer to FIG. 2. It illustrates a functional diagram of a contactless IC card system for use with a portable communication apparatus according to the present invention. As shown in FIG. 2, a contactless IC card 60 is disposed in the portable communication apparatus 70. The portable communication apparatus 70 includes a casing 701 and the contactless IC card 60 is hold therein. The contactless IC card system includes the contactless IC card 60, a pad set 601 disposed on the casing 701 of the portable communication apparatus 70; a connecting circuit 602 for connecting the contactless IC card 60 to the pad set 601; and an antenna 80 disposed on the casing 701 of the portable communication apparatus 70, having a contact terminal set 801 covering the pad set 601 for coupling to the contactless IC card 60 and transmitting data wirelessly. In practice, the portable communication apparatus 70 could be a mobile phone or a personal digital assistant. Furthermore, the antenna 80 could be a flexible antenna which is looped or wound on a flexible board.

Accordingly, the present invention introduces a pad set to connect with the inner contactless IC card and provides connecting ends to an external antenna. If the portable communication apparatus includes a pad set and a connecting circuit, it is easy and convenient to build a contactless transmission system in the portable communication apparatus. Meanwhile, the contactless IC card could provide some identification data to perform the electronic transaction function via the antenna. In this manner, a service provider may determine the communication parameters of the contactless IC card 60. It should be noted that the antenna 80 is different from the antenna of the portable communication apparatus 70. It is a low power transmission antenna for contactless or Near Field Communication (NFC). Contactless transaction provides advantages over contact-type cards, such as faster transaction speed and ease of use.

The transfer or reading of data for contactless transaction via the contactless IC card 60 is achieved by sending RF signals through the antenna 80 via the pad set 601 and the connecting circuit 602. The user simply brings the contactless IC card 60 with the function of contactless transaction close to a card reader within a range; the reader is enabled to read the identification data contained in the contactless IC card 60 via the antenna 80. As well known in the art, when a contactless transaction is used in a transportation system, the IC mounted in the contactless IC card 60 contains the user's account information or billing information. During the operation, the user may access or update the user's account. The contactless IC card 60 may be formed of a plastic material.

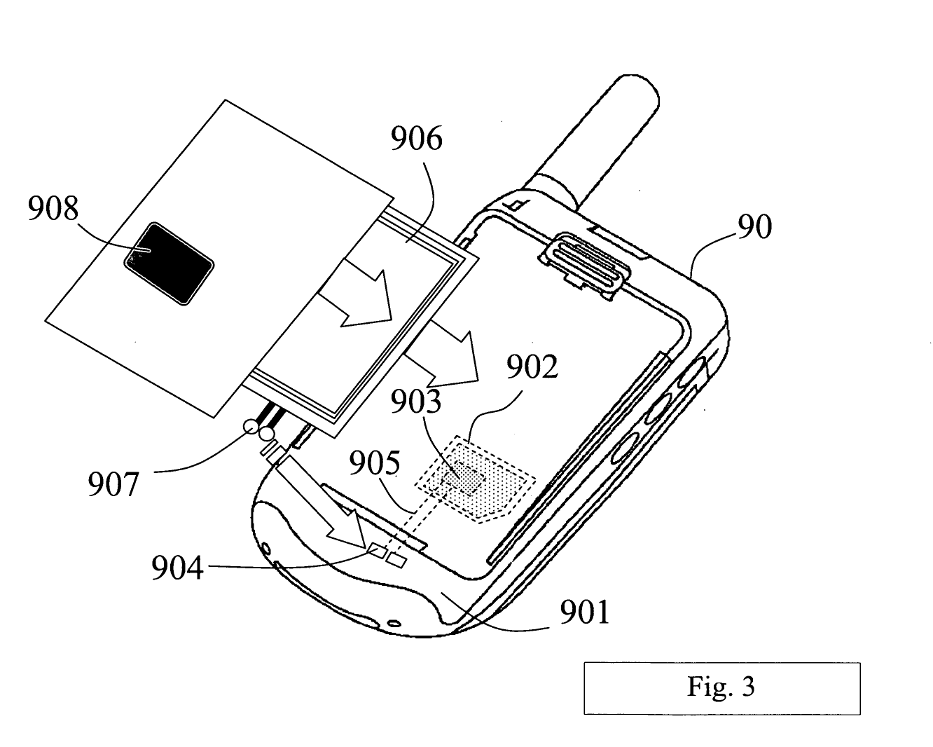

Please refer to FIG. 3. It further illustrates a portable communication apparatus with a contactless IC card system for a contactless transmission according to the present invention. As shown in FIG. 3, the portable communication apparatus for a contactless transmission includes a main device 90 having a casing 901 and a socket 902 disposed therein for holding a contactless IC card 903; a pad set 904 disposed on the casing 901 of the main device 90; a connecting circuit 905 for electrically connecting the socket 902 to the pad set 904; and an antenna 906 disposed on the casing 901, having a contact terminal set 907 covering the pad set 904 for coupling to the contactless IC card 903 via the connecting circuit 905 and transmitting data wirelessly while the contactless IC card 903 is inserted into the socket 902.

In practice, the portable communication apparatus 70 could be a mobile phone or a personal digital assistant, certainly. The contactless IC card system further includes a hologram 908 disposed on the antenna 906. The hologram 908 forms a thin covering slice to cover the entire antenna 906 for decorating and preventing counterfeiting. Certainly, the antenna 906 is looped or wound on a flexible board.

For identifying whether the user is a legal user, a hologram (as mentioned above), user's picture, signature panel, credit card number, or issuer's logo may also be provided over the surface of the antenna.

Furthermore, the antenna 906 can be manufactured separately. In other words, the antenna 906 may not need to be manufactured along with the manufacturing of the portable communication apparatus 70, whereas the antenna 906 can be provided according to the contactless IC card 903 which may have different frequencies. Different antennas can be attached to the contactless IC card 903 of the portable communication apparatus 70 by connecting the contact terminal set 907 disposed on the antenna to the pad set 904 disposed on the contactless IC card 903 via the connecting circuit 905. By this way, the production cost of a portable communication apparatus with a contactless IC card system may certainly be lowered.

Meanwhile, the substrate material for the contactless IC card may be made from a plastic material similar to those used in credit cards. In one example, the material, the shape and dimension of the contactless IC card are adapted to the standard SIM card applied in a mobile phone.

In conclusion, the present invention provides a contactless IC card system for use with a communication terminal, which introduces a pad set disposed outside of the communication terminal for facilitating to build a contactless IC card system into the communication terminal conveniently regardless of the size of external antenna.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A contactless IC card system for use with a portable communication apparatus having a casing, comprising:
a contactless IC card disposed in said portable communication apparatus;
a pad set disposed on said casing of said portable communication apparatus;
a connecting circuit for connecting said contactless IC card to said pad set; and
an antenna disposed on said casing of said portable communication apparatus, having a contact terminal set covering said pad set for coupling to said contactless IC card and transmitting data wirelessly.

2. The contactless IC card system according to claim 1, wherein said portable communication apparatus is one of a mobile phone and a personal digital assistant.

3. The contactless IC card system according to claim 1, further comprising a hologram disposed on said antenna.

4. The contactless IC card system according to claim 1, wherein said antenna is a flexible antenna.

5. The contactless IC card system according to claim 4, wherein said flexible antenna is looped or wound on a flexible board.

6. A portable communication apparatus for contactless transmission, comprising:
a main device having a casing and a socket disposed therein for holding a contactless IC card;
a pad set disposed on said casing of said main device;
a connecting circuit for electrically connecting said socket to said pad set; and
an antenna disposed on said casing, having a contact terminal set covering said pad set for coupling to said contactless IC card via said connecting circuit and transmitting data wirelessly while said contactless IC card is inserted into said socket.

7. The portable communication apparatus according to claim 6, wherein said portable communication apparatus is one of a mobile phone and a personal digital assistant.

8. The portable communication apparatus according to claim 6, further comprising a hologram disposed on said antenna.

9. The portable communication apparatus according to claim 6, wherein said antenna is looped or wound on a flexible board.
